(19) United States
(12) Patent Application Publication
(10) Pub. No.: US 2021/0068355 A1
(43) Pub. Date: Mar. 11, 2021

(54) BIODEGRADABLE FABRIC AND USE OF SUCH FABRIC

(71) Applicant: Beaulieu International Group NV, Waregem (BE)

(72) Inventors: Laurens Jean-Marc L. GOORMACHTIGH, Waregem (BE); Femke FAELENS, Gent (BE); Frans VAN GIEL, Kortrijk (BE)

(21) Appl. No.: 16/956,216

(22) PCT Filed: Dec. 20, 2018
(86) PCT No.: PCT/EP2018/086313

§ 371 Date: Jun. 19, 2020

(30) Foreign Application Priority Data
Dec. 21, 2017 (EP) 17209324.7

(51) Int. Cl. A01G 13/02; B32B 5/26; B32B 27/12; B32B 27/36; D01D 5/42; D01F 6/62; D06N 3/00; D06N 3/12

(52) U.S. Cl. CPC A01G 13/0268; D06N 2211/24; B32B 27/12; B32B 27/36; D01D 5/426; D01F 6/625; D06N 3/0036; D06N 3/123; B32B 2307/7163; D06N 2209/1614; B32B 2262/0276; B32B 2250/40; B32B 2410/00; B32B 2250/02; B32B 2250/244; B32B 2439/06; B32B 2555/00; D06N 2201/12; D06N 2211/02; D06N 2211/20; B32B 5/26

(57) ABSTRACT

The invention relates to a multilayered composite textile, comprising at least one first layer, comprising a first biodegradable polymer; and, at least one second layer, comprising a second layer fabric wherein the second layer fabric comprises second layer filaments; wherein said second layer fabric comprises a second biodegradable polymer, characterized in that, the visual degradation speed of the first layer is slower than the visual degradation speed of the second layer. The invention further relates to the use of such fabric for temporary weed control, temporary erosion control, as a hygienic article, or temporary packaging material.

### FIELD OF THE INVENTION

The invention relates to a biodegradable textile, relates to a method for influencing the speed of degradation of the biodegradable textile and to the use of the biodegradable textile.

### BACKGROUND OF THE INVENTION

Biodegradable groundcovers currently on the market are often made from natural materials, such as coco mats. However, these natural materials are often lacking mechanical integrity, are often characterized by low tensile strengths, making them unsuitable for some applications, and/or are often too thick and too heavy to compensate for the lack of mechanical properties.

Although the use of biodegradable polymers is becoming more and more popular, the uses are being restricted by the properties of the biodegradable polymers, such as tensile strength or the speed of disintegration. Quite often the tensile strength is not sufficient for a certain use or the speed of disintegration is too slow or too fast. For some uses, there is quite a specific demand in terms of tensile strength and in terms of visual disintegration.

To provide a textile with a certain tensile strength, a certain thickness of biodegradable polymer is needed. However the thickness of the textile is directly linked to the time it takes for the textile to visually degrade. Often this time is too long or too short for a certain application. Therefore, there is a demand in the art to control the visual degradation time for a textile that has to have certain strength.

There is also a demand in the art for a biodegradable textile, that degrades slowly in a first period (preferably 3 to 5 years) and that in that first period preferably remains structurally intact, followed by a fast degradation until complete visual degradation (preferably within one year or less).

There is a demand for a groundcover which can be used in new plantations, to control weed growth between the newly planted plants, which visually disintegrates once the newly planted plants have grown to a certain size so that the plants themselves can suppress the growth of weed. For this use, the desired visual disintegration time is between 3 and 5 years. However, especially in the first years, the groundcover needs to be robust enough in terms of tensile strength, preferably at least 12 cN/tex, to withstand the conditions in the new plantation. Preferably, the groundcover has elongation at break of at least 15%.

There is also a demand for a groundcover which can be used to temporarily stop erosion. For example, to stabilize earth works or dunes until the roots of plants that are planted on these earthworks or dunes are strong enough to stabilize them by themselves. At that point the groundcover can disappear. For this use, the desired visual disintegration time is between 2 and 4 years. However, the tensile strength of the groundcover needs to be large enough to withstand the elements and stop erosion.

It is accordingly one of the objects of the present invention to overcome or ameliorate one or more of the aforementioned disadvantages present in the market, or to meet any of the demands that are present in the market. Preferably the invention also provides a groundcover that creates a microclimate for plants. Preferably the invention also provides a groundcover that is light, preferably lighter than groundcovers made of natural materials. Preferably the invention also provides a groundcover that comprises renewable materials. Preferably the invention also provides a groundcover that visually degrades without harm to the environment in outdoor environments. Preferably the invention also provides a groundcover that requires no maintenance after installation and that disappears completely without any intervention. Preferably the invention also provides a groundcover that has low shrinkage when exposed to elevated temperatures. Preferably the invention also provides a groundcover that has good burning behaviour (preferably passes ISO 12952-2 and/or ISO 12952-3). For example, the invention also provides a groundcover that is degradable according to the EN 13432 norm. Preferably the invention provides an easy to produce groundcover. Preferably, the invention provides a groundcover which is homogeneous in terms of composition, mechanical properties, and/or biodegradability. Preferably, the groundcover can be easily produced. Preferably, the material of the groundcover is compatible with most common colourants, and/or vice versa.

### SUMMARY OF THE INVENTION

The present inventors have now surprisingly found that one or more of these objects can be obtained by using multilayered composite textiles.

In a first aspect, the invention provides a multilayered composite textile, comprising:
at least one first layer, comprising a first biodegradable polymer; and,
at least one second layer, comprising a second layer fabric wherein the second layer fabric comprises second layer filaments;
   wherein said second layer fabric comprises a second biodegradable polymer, preferably wherein the visual degradation speed of the first layer is slower than the visual degradation speed of the second layer.

Additionally, the first aspect provides a multilayered composite textile, comprising:
at least one first layer, comprising a first biodegradable polymer; and,
at least one second layer, comprising a second layer fabric wherein the second layer fabric comprises second layer filaments;
   wherein said second layer fabric comprises a second biodegradable polymer, characterized in that the first biodegradable polymer comprises polybutylene succinate (PBS), polylactic acid (PLA) and/or polybutyrate (PBAT); and wherein the second biodegradable polymer comprises polycaprolactone (PCL), polybutylene succinate-co-adipate (PBSA), and/or polyhydroxyalkanoate (PHA).

Additionally, the first aspect provides in a multilayered composite textile, comprising:
at least one first layer, comprising a first biodegradable polymer; and,
at least one second layer, comprising a second layer fabric wherein the second layer fabric comprises second layer filaments;
   wherein said second layer fabric comprises a second biodegradable polymer, characterized in that the first biodegradable polymer comprises polylactic acid (PLA); and wherein the second biodegradable polymer comprises polybutylene succinate (PBS) and/or polybutyrate (PBAT).

In some embodiments, the first layer comprises a coating comprising the first biodegradable polymer.

In some embodiments, wherein the second layer filaments are slit film tapes, fibres, or yarns, preferably slit film tapes. In some embodiments, the second layer fabric is a woven fabric or non-woven fabric, preferably a woven fabric, preferably woven from the second layer filaments.

In some embodiments, the visual degradation speed of the first layer is at least 50% slower than the visual degradation speed of the second layer, preferably at least 100% slower, more preferably at least 200% slower, more preferably at least 500% slower, more preferably at least 1000% slower under conditions according to modified ISO 20200:2015. Any test method for the determination of a visual degradation speed can be used to determine the relative visual degradation speed of two layers, as long as the same conditions are used in the test method. For example the ISO 17556:2012 or EN 17033:2018 could be used for relative visual degradation speeds of two layers. Alternatively, also the modified ISO 20200:2015 norm could be used. In the unlikely event that the results of different test contradict each other, the modified ISO 20200:2015 norm is the preferred method.

In some embodiments, the first layer comprises polybutylene succinate (PBS) and/or polybutyrate (PBAT), preferably wherein the first layer comprises at least 50 to at most 100 percent by weight PBS and/or PBAT, preferably at least 60 to at most 100 percent by weight PBS and/or PBAT, preferably at least 70 to at most 100 percent by weight PBS and/or PBAT, preferably at least 80 to at most 100 percent by weight PBS and/or PBAT, preferably at least 90 to at most 100 percent by weight PBS and/or PBAT; the percentage by weight expressed compared to the total weight of the first layer.

In some embodiments, the first layer comprises polylactic acid (PLA), preferably wherein the first layer comprises at least 50 to at most 100 percent by weight PLA, preferably at least 60 to at most 100 percent by weight PLA, preferably at least 70 to at most 100 percent by weight PLA, preferably at least 80 to at most 100 percent by weight PLA, preferably at least 90 to at most 100 percent by weight PLA; the percentage by weight expressed compared to the total weight of the first layer.

In some embodiments, the second layer comprises polycaprolactone (PCL), polybutylene succinate-co-adipate (PBSA), polyhydroxyalkanoate (PHA), or a mixture thereof, preferably PCL and/or PHA, preferably wherein the second layer comprises at least 50 to at most 100 percent by weight PCL, PBSA and/or PHA, preferably at least 60 to at most 100 percent by weight PCL, PBSA and/or PHA, preferably at least 70 to at most 100 percent by weight PCL, PBSA and/or PHA, preferably at least 80 to at most 100 percent by weight PCL, PBSA and/or PHA, preferably at least 90 to at most 100 percent by weight PCL, PBSA and/or PHA; the percentage by weight expressed compared to the total weight of the second layer.

In some embodiments, the second layer comprises polybutylene succinate (PBS) and/or polybutyrate (PBAT), preferably wherein the second layer comprises at least 50 to at most 100 percent by weight PBS and/or PBAT, preferably at least 60 to at most 100 percent by weight PBS and/or PBAT, preferably at least 70 to at most 100 percent by weight PBS and/or PBAT, preferably at least 80 to at most 100 percent by weight PBS and/or PBAT, preferably at least 90 to at most 100 percent by weight PBS and/or PBAT; the percentage by weight expressed compared to the total weight of the second layer.

In some embodiments, the second layer is sandwiched between two first layers. In some embodiments, the second layer may be sandwiched between two first layers each of these first layers having a different composition.

In some embodiments, the first layer has a thickness of at least 0.1 μm to at most 50 μm, preferably at least 0.5 μm to at most 40 μm, more preferably at least 0.7 μm to at most 30 μm, still more preferably at least 1 μm to at most 20 μm, even more preferably at least 2 μm to at most 15 μm and most preferably at least 3 μm to at most 10 μm, such as at least 4 μm to at most 5 μm.

In some embodiments, the second layer has a thickness of at least 3 μm to at most 100 μm, preferably at least 5 μm to at most 90 μm, more preferably at least 7 μm to at most 80 μm, still more preferably at least 10 μm to at most 70 μm, even more preferably at least 15 μm to at most 60 μm and most preferably at least 18 μm to at most 55 μm, such as at least 20 μm to at most 50 μm.

In some embodiments, the fabric is geotextile or an agrotextile, preferably a groundcover.

In a second aspect, the invention provides in a method for manufacturing a multilayered composite textile, preferably according to the first aspect or an embodiment thereof, comprising the steps of:
providing second layer filaments, comprising a second biodegradable polymer;
forming, preferably weaving, said second layer filaments into a second layer fabric;
covering said second layer fabric with at least one first layer, wherein the first layer comprises a first biodegradable polymer, to obtain a multilayered composite textile, preferably wherein the visual degradation speed of the first biodegradable polymer is slower than the visual degradation speed of the second biodegradable polymer.

Additionally, the second aspect provides in a method for manufacturing a multilayered composite textile, preferably according to the first aspect or an embodiment thereof, comprising the steps of:
providing second layer filaments, comprising a second biodegradable polymer;
forming, preferably weaving, said second layer filaments into a second layer fabric;
covering said second layer fabric with at least one first layer, wherein the first layer comprises a first biodegradable polymer, to obtain a multilayered composite textile, wherein the first biodegradable polymer comprises polybutylene succinate (PBS), polylactic acid (PLC) and/or polybutyrate (PBAT); and wherein the second biodegradable polymer comprises polycaprolactone (PCL), polybutylene succinate-co-adipate (PBSA), and/or polyhydroxyalkanoate (PHA).

Additionally, the second aspect provides in a method for manufacturing a multilayered composite textile, preferably according to the first aspect or an embodiment thereof, comprising the steps of:
providing second layer filaments, comprising a second biodegradable polymer;
forming, preferably weaving, said second layer filaments into a second layer fabric;
covering said second layer fabric with at least one first layer, wherein the first biodegradable polymer comprises polylactic acid (PLA); and wherein the second biodegradable polymer comprises polybutylene succinate (PBS) and/or polybutyrate (PBAT).

In some embodiments, the covering step is performed by dip coating one layer with the other layer, hot melt coating one layer with the other layer, co-extrusion, bi-component extrusion, laminating, or via plasma treatment of at least one layer.

In some embodiments, the second layer fabric is dip-coated with the first biodegradable polymer.

In a third aspect, the invention provides in the use of a multilayered composite textile according to the first aspect or an embodiment thereof, or a multilayered composite textile manufactured by a method according to the second aspect or an embodiment thereof, as temporary weed control, as temporary erosion control, as a hygienic article, or as temporary packaging material.

Preferred embodiments of the invention are disclosed in the detailed description and appended claims. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. (Preferred) embodiments of one aspect of the invention are also (preferred) embodiments of all other aspects of the invention.

### BRIEF DESCRIPTION OF THE FIGURES

FIG. 1 represent visual degradation profiles of hypothetical fabrics, in function of time when the fabrics are in contact with soil, exposed to the elements of a Cfb-climate the lines numbered 1 and 2 are the theoretical ideal situation, wherein the second layer degrades fast once the first layer has degraded.

FIG. 2 shows a multilayered composite textile 3 according to an embodiment of the invention. The multilayered composite textile comprises a first layer 1 and a second layer 2, wherein the second layer comprises a second layer fabric 4, woven from second layer filaments 5, here slit film tapes.

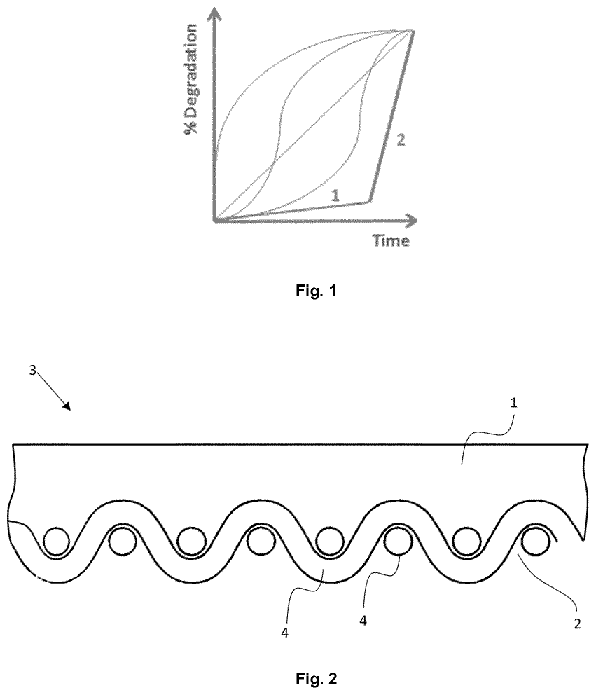

### DETAILED DESCRIPTION OF THE INVENTION

When describing the invention, the terms used are to be construed in accordance with the following definitions, unless a context dictates otherwise.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

As used in the specification and the appended claims, the singular forms “a”, “an,” and “the” include plural referents unless the context clearly dictates otherwise. By way of example, “a filament” means one filament or more than one filament. As used herein, the term “polymer” comprises homopolymers (e.g., prepared from a single monomer species), copolymers (e.g., prepared from at least two monomer species), and graft polymers.

Unless defined otherwise, all technical and scientific terms used herein have the same meaning as is commonly understood by one of skill in the art. All publications referenced herein are incorporated by reference thereto.

Throughout this application, the term ‘about’ is used to indicate that a value includes the standard deviation of error for the device or method being employed to determine the value.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

In a first aspect, the invention provides in a multilayered composite textile, comprising:
at least one first layer, comprises a first biodegradable polymer; and,
at least one second layer, comprising a second layer fabric wherein the second layer fabric itself comprises second layer filaments;
   wherein said second layer fabric comprise a second biodegradable polymer, preferably wherein the visual degradation speed of the first layer is slower than the visual degradation speed of the second layer.

Additionally, the first aspect provides in a multilayered composite textile, comprising:
at least one first layer, comprises a first biodegradable polymer; and,
at least one second layer, comprising a second layer fabric wherein the second layer fabric itself comprises second layer filaments;
   wherein said second layer fabric comprises a second biodegradable polymer, characterized in that the first biodegradable polymer comprises polybutylene succinate (PBS), polylactic acid (PLA) and/or polybutyrate (PBAT); and wherein the second biodegradable polymer comprises polycaprolactone (PCL), polybutylene succinate-co-adipate (PBSA) and/or polyhydroxyalkanoate (PHA).

Additionally, the first aspect provides in a multilayered composite textile, comprising:
at least one first layer, comprises a first biodegradable polymer; and,
at least one second layer, comprising a second layer fabric wherein the second layer fabric itself comprises second layer filaments;
   wherein said second layer fabric comprises a second biodegradable polymer, characterized in that the first biodegradable polymer comprises polylactic acid (PLA); and wherein the second biodegradable polymer comprises polybutylene succinate (PBS) and/or polybutyrate (PBAT).

In some preferred embodiments, the visual degradation speed of the first layer is slower than the visual degradation speed of the second layer.

In some preferred embodiments, the first biodegradable polymer comprises polybutylene succinate (PBS) and/or polybutyrate (PBAT) and wherein the second biodegradable polymer comprises polycaprolactone (PCL), polybutylene succinate-co-adipate (PBSA) and/or polyhydroxyalkanoate (PHA).

In some preferred embodiments, the first biodegradable polymer comprises polylactic acid (PLA) and wherein the second biodegradable polymer comprises polybutylene succinate (PBS) and/or polybutyrate (PBAT).

The term “multilayered composite textile” refers to textiles that comprise two or more layers of a different material, preferably at least two different polymers or polymer compositions.

The term “visual disintegration” refers to degradation of a material to the extent that it cannot be seen by the naked eye anymore (100% visual disintegration), preferably disintegration into pieces smaller than 0.10 mm, more preferably smaller than 0.05 mm. Uncomplete visual degradation can be expressed as a percentage of the material that has visually disappeared compared to the material before the disintegration started.

In some embodiments, the visual degradation speed of the first and second biodegradable polymers is compared to each other when in contact with soil under the same conditions, preferably under conditions according to ISO 20200:2015 and more preferably under conditions according to the modified ISO 20200:2015 as disclosed in the example section.

The expression “same conditions” preferably refers to identical conditions in terms of temperature, surface percentage of the textile that is in contact with the soil, biological activity in the soil, soil composition, humidity, and light conditions.

A preferred method to measure the visual degradation test of filaments, textiles, fabrics, or groundcovers is the modified ISO EN 20200:2015 norm as explained in the example section. In some embodiments, other test can be used to compare the speed of visual degradation of two biodegradable polymers, such as the unmodified ISO EN 20200:2015 norm, or any test applying the same condition for biodegradable polymers.

Amongst others, OWS nv (organic waste systems), a company in Ghent, Belgium, may be suitable to carry out the modified ISO EN 20200:2015 test.

As used herein, the term “biodegradable polymer” refers to a polymer fulfilling the requirements of EN 13432:2000.

In some embodiments, the at least first layer and/or the at least second layer is a continuous layer, meaning that there are no holes in the layer larger than 500 μm, preferably larger than 250 μm, more preferably larger than 100 μm, even more preferably larger than 50 μm, and most preferably larger than 10 μm. In some alternative embodiments, the at least first layer is perforated allowing water to penetrate through the fabric.

In some embodiments, the first layer comprises a coating comprising the first biodegradable polymer.

In some embodiments, wherein the second layer filaments are slit film tapes, fibres, or yarns, preferably slit film tapes.

In some embodiments, the second layer fabric is a woven fabric or non-woven fabric, preferably a woven fabric, preferably woven from the second layer filaments.

The term “slit film tape” refers to a filament that is made by cutting a film into tapes. In some embodiments, the slit film tapes are stretched after they have been slit from the film. In some alternative embodiments, the film is stretched before it is slit into tapes. Stretching the tape increases the tensile strength of the tape. The term “raffia” is a synonym for slit film tape.

The term “fibre” refers to a single strand of untwisted elongated material, fibres include staple fibres and short cut fibres. “Staple fibres” are fibres of limited length, e.g. 20 to 120 mm or up to 300 mm. “Short-cut fibres” are cut fibres of a length from 2 to 25 mm and are generally not crimped. The term “yarn” can refer to a two or more fibres that are interlocked, spun or twisted and form one filament. A continuous thread is also considered a yarn. Yarns include multi-filaments, monofilaments, continuous filaments, bulked continuous filaments, spun yarn, partially oriented yarn and fully drawn yarn.

In some embodiments, the filament has a tensile strength at break of at least 10 cN/tex, preferably of at least 12 cN/tex, more preferably of at least 15 cN/tex, even more preferably of at least 17 cN/tex, and most preferably of at least 20 cN/tex, determined according to ISO 2062(2009), using the following parameters: pretension of 0.5 cN/tex; rate of extension 500 mm/min gauge length 500 mm.

In some embodiments, the filament has a tensile strength at break of at least 10 cN/tex to at most 100 cN/tex, preferably of at least 12 cN/tex to at most 90 cN/tex, more preferably of at least 15 cN/tex to at most 80 cN/tex, even more preferably of at least 17 cN/tex to at most 70 cN/tex, and most preferably of at least 20 cN/tex to at most 60 cN/tex, determined according to ISO 2062(2009), using the following parameters: pretension of 0.5 cN/tex; rate of extension 500 mm/min; gauge length 500 mm.

In some embodiments, the filament has an elongation at break of at least 10%, preferably of at least 13%, more preferably of at least 15%, even more preferably of at least 17%, and most preferably of at least 20%, determined according to ISO 2062(2009), using the following parameters: pretension of 0.5 cN/tex; rate of extension 500 mm/min; gauge length 500 mm.

In some embodiments, the filament comprises PCL and has an elongation at break of at least 15%, preferably of at least 20%, more preferably of at least 25%, even more preferably of at least 27%, and most preferably of at least 30%, determined according to ISO 2062(2009), using the following parameters: pretension of 0.5 cN/tex; rate of extension 500 mm/min; gauge length 500 mm.

In some embodiments, the visual degradation speed of the first layer is slower than the visual degradation speed of the second layer. In some embodiments, the visual degradation speed of the first layer is at least 50% slower than the visual degradation speed of the second layer, preferably at least 100% slower, more preferably at least 200% slower, more preferably at least 500% slower, more preferably at least 1000% slower, under conditions according to modified ISO 20200:2015.

In some embodiments, the visual degradation of the first layer preferably in contact with soil exposed to the elements in a Cfb-climate is at least 1 year to at most 8 years, preferably at least 1.5 years to at most 6 years, more preferably at least 2 years to at most 5 years and more preferably at least 3 years to at most 4 years. The Cfb-climate being a climate classification according to the Köppen-Geiger climate classification system.

In some embodiments, the visual degradation of the second layer preferably in contact with soil exposed to the elements in a Cfb-climate is at least 1 week to at most 36 months, preferably at least 2 weeks to at most 24 months, more preferably at least 3 weeks to at most 18 months, more preferably at least 1.0 months to at most 12 months, still more preferably at least 1.5 month to at most 6 months and most preferably 2 months to 3 months, wherein a month corresponds to 30.4 days.

In some embodiments, the visual degradation of the multilayered composite textile preferably in contact with soil exposed to the elements in a Cfb-climate, is at least 1.5 year to at most 8.5 years, preferably at least 2 years to at most 6.5 years, more preferably at least 2.5 years to at most 5.5 years and more preferably at least 3.5 years to at most 4.5 years.

In some preferred embodiments, the visual degradation speed of the first layer is such that at most 10% visual degradation occurs in a period of at least 25 weeks, preferably at least 30 weeks, more preferably at least 35 weeks, even more preferably 40 weeks, and most preferably at least 42 weeks; under conditions according to modified ISO 20200:2015.

In some embodiments, the structural integrity of the multilayered composite textile preferably in contact with soil exposed to the elements in a Cfb-climate, is at least 1.5 year to at most 7.0 years, preferably at least 2 years to at most 6.5 years, more preferably at least 2.5 years to at most 5.5 years and more preferably at least 3.5 years to at most 5.0 years, after that complete visual degradation occurs in 0.5 to 2.5 years, preferably in 1.0 to 2.0 years.

In some preferred embodiments, the visual degradation speed of the second biodegradable layer is such that at least 80% visual degradation occurs in a period of at most 6 weeks, preferably at most 5 weeks, preferably at most 4 weeks; under conditions according to modified ISO 20200:2015.

Preferably the biodegradable polymers are selected from the group comprising polycaprolactone (PCL), polyhydroxyalkanoate (PHA), polylactic acid (PLA), polybutylene succinate (PBS), polybutyrate adipate terephthalate (PBAT), polybutylene succinate adipate (PBSA), or any combination thereof. In some embodiments, under similar conditions, these polymers can be ordered according to their visual degradation speed from slow to fast: PLA<PBAT<PBS<PHA=PCL=PBSA.

In some embodiments, the first layer comprises polybutylene succinate (PBS) and/or polybutyrate (PBAT), preferably wherein the first layer comprises at least 50 to at most 100 percent by weight PBS and/or PBAT, preferably at least 60 to at most 100 percent by weight PBS and/or PBAT, preferably at least 70 to at most 100 percent by weight PBS and/or PBAT, preferably at least 80 to at most 100 percent by weight PBS and/or PBAT, preferably at least 90 to at most 100 percent by weight PBS and/or PBAT; the percentage by weight expressed compared to the total weight of the first layer.

In some embodiments, the first layer comprises polylactic acid (PLA), preferably wherein the first layer comprises at least 50 to at most 100 percent by weight PLA, preferably at least 60 to at most 100 percent by weight PLA, preferably at least 70 to at most 100 percent by weight PLA, preferably at least 80 to at most 100 percent by weight PLA, preferably at least 90 to at most 100 percent by weight PLA; the percentage by weight expressed compared to the total weight of the first layer.

In some embodiments, the second layer comprises polycaprolactone (PCL), polybutylene succinate-co-adipate (PBSA), polyhydroxyalkanoate (PHA), or a mixture thereof, preferably PCL and/or PHA, preferably wherein the second layer comprises at least 50 to at most 100 percent by weight PCL, PBSA and/or PHA, preferably at least 60 to at most 100 percent by weight PCL, PBSA and/or PHA, preferably at least 70 to at most 100 percent by weight PCL, PBSA and/or PHA, preferably at least 80 to at most 100 percent by weight PCL, PBSA and/or PHA, preferably at least 90 to at most 100 percent by weight PCL, PBSA and/or PHA; the percentage by weight expressed compared to the total weight of the second layer.

In some embodiments, the second layer comprises polybutylene succinate (PBS) and/or polybutyrate (PBAT), preferably wherein the second layer comprises at least 50 to at most 100 percent by weight PBS and/or PBAT, preferably at least 60 to at most 100 percent by weight PBS and/or PBAT, preferably at least 70 to at most 100 percent by weight PBS and/or PBAT, preferably at least 80 to at most 100 percent by weight PBS and/or PBAT, preferably at least 90 to at most 100 percent by weight PBS and/or PBAT; the percentage by weight expressed compared to the total weight of the second layer.

In some embodiments, the first layer can comprise a single polymer, or can comprise a blend of polymers.

In some embodiments, the second layer can comprise a single polymer, or can comprise a blend of polymers.

In some embodiments, the melt flow index (MFI) of the first biodegradable polymer is at least 0.5 g/10 min to at most 50.0 g/10 min, preferably at least 1.0 g/10 min to at most 30.0 g/10 min. In some preferred embodiments where the first layer comprises tapes or slit film tapes that comprise the first biodegradable polymer, the MFI of the first biodegradable polymer is preferably at least 1.0 g/10 min to at most 10.0 g/10 min, preferably at least 2.0 g/10 min to at most 7.0 g/10 min. In some alternative preferred embodiments where the first layer comprises yarns that comprise the first biodegradable polymer, the MFI of the first biodegradable polymer is preferably at least 10.0 g/10 min to at most 30.0 g/10 min, preferably at least 15.0 g/10 min to at most 25.0 g/10 min, according to ISO 1133:2005 at 190° C. under a weight of 2.16 kg.

In some embodiments, the MFI of the second biodegradable polymer is at least 0.5 g/10 min to at most 50.0 g/10 min, preferably at least 1.0 g/10 min to at most 30.0 g/10 min.

In some preferred embodiments where the second layer filaments are tapes or slit film tapes, the MFI of the second biodegradable polymer is preferably at least 1.0 g/10 min to at most 10.0 g/10 min, preferably at least 2.0 g/10 min to at most 7.0 g/10 min. In some alternative preferred embodiments where the second layer filaments are yarns, the MFI of the second biodegradable polymer is preferably at least 10.0 g/10 min to at most 30.0 g/10 min, preferably at least 15.0 g/10 min to at most 25.0 g/10 min, according to ISO 1133:2005 at 190° C. under a weight of 2.16 kg.

In some preferred embodiments, the ratio of the MFI of the first biodegradable polymer over the MFI of the second biodegradable polymer, at the same temperature, is at least 0.75 to at most 1.33, preferably at least 0.80 to at most 1.25, more preferably at least 0.85 to at most 1.18, even more preferably at least 0.90 to at most 1.11 and most preferably at least 0.95 to at most 1.05.

Polycaprolactone (PCL) is a polymer that is obtained by polymerization of caprolactone, more preferably ε-caprolactone. The polymerization is preferably carried out via ring opening polymerization, more preferably anionic ring opening polymerization. The polymerization may be carried out in the presence of an initiator and/or a catalyst. Both suitable initiators and catalyst are known in the art. Examples of suitable initiators are nucleophilic reagents, such as metal amides, alkoxides, phosphines, amines, alcohols, water or organometals, e.g. alkyl lithium, alkyl magnesium bromide, alkyl aluminium, etc.

Examples of suitable catalysts are stannous (II) 2-ethylhexanoate a.k.a. stannous octoate or [Sn(Oct)₂], aluminium tri-isopropoxide, lanthanide isopropoxide.

Polycaprolactone comprises structure (I) as repeating motif, the end groups depend on the used initiator and/or catalyst.

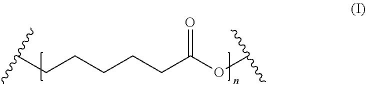

In some embodiments, the weight average molecular weight of the polycaprolactone ranges from at least 100 000 to at most 140 000 g/mol, preferably at least 110 000 to at most 130 000 g/mol, more preferably at least 115 000 g/mol to at most 120 000 g/mol determined by gel permeability chromatography (GPC) in THE at 25° C.

In some embodiments, the melting point of the polycaprolactone ranges from 45 to 70° C., more preferably from 50 to 65° C., even more preferably from 52 to 62° C., and most preferably from 54 to 60° C., determined according to ISO 11357-1 (2016) using a heating rate of 10° C./min.

In some embodiments, the melt flow index (MFI) of the polycaprolactone is at least 0.1 g/10 min to at most 50.0 g/10 min, preferably at least 0.2 g/10 min to at most 30.0 g/10 min, more preferably at least 0.3 g/10 min to at most 10.0 g/10 min, even more preferably at least 0.4 g/10 min to at most 5.0 g/10 min and most preferably at least 0.5 g/10 min to at most 1.0 g/10 min measured according to D 1238, at 80° C. and under a load of 2.16 kg.

In some embodiments, the first biodegradable polymer and/or second biodegradable polymer comprises at most 10 percent by weight PCL, preferably at most 7 percent by weight PCL and most preferably at most 5 percent by weight PCL. In some embodiments, PCL is used as an additive to provide extra tensile strength to the filament, in addition to the first and second biodegradable polymer.

Polyhydroxyalkanoate (PHA) is a polymer that can be classified as a polyester, preferably a linear polyester. Polyhydroxyalkanoate can be produced by bacterial fermentation of lipids and sugar, such as glucose. In some embodiments, the polyhydroxyalkanoate is produced biosynthetically. In some embodiments, the polyhydroxyalkanoate is biodegradable.

In some embodiments, the melting point of the polyhydroxyalkanoate is at least 40° C. and at most 180° C., preferably at least 80° C. to at most 175° C., more preferably at least 120° C. to at most 170° C. and most preferably at least 140 to at most 150° C., determined according to ISO 11357-1 (2016) using a heating rate of 10° C./min.

In some embodiments, the weight average molecular weight of the polyhydroxyalkanoate is at least 400 000 to at most 700 000 g/mol, preferably at least 450 000 to at most 650 000 g/mol, more preferably at least 500 000 to at most 600 000 g/mol, determined by gel permeability chromatography (GPC) in THE at 25° C.

In some embodiments, the melt flow index (MFI) of the PHA is at least 0.1 g/10 min to at most 30.0 g/10 min, preferably at least 0.2 g/10 min to at most 20.0 g/10 min, more preferably at least 0.5 g/10 min to at most 10.0 g/10 min, and most preferably at least 1.0 g/10 min to at most 5.0 g/10 min measured according to D 1238, at 160° C. and under a load of 2.16 kg.

In some embodiments, the polyhydroxyalkanoate (PHA) is selected from the group comprising: poly-3-hydroxybutyrate (P3HB), poly-4-hydroxybutyrate (P4HB), poly-3-hydroxyvalerate (PHV), poly(3-hydroxybutyrate-co-3-hydroxyvalerate) (PHBV), poly-3-hydroxyhexanoate (PHH) or a copolymer thereof, preferably poly(3-hydroxybutyrate-co-3-hydroxyvalerate) (PHBV) or a copolymer (PHBH) of poly-3-hydroxybutyrate and poly-3-hydroxyhexanoate, most preferably a copolymer (PHBH) of poly-3-hydroxybutyrate and poly-3-hydroxyhexanoate.

In some preferred embodiments, the PHA is a copolymer (PHBH) of poly-3-hydroxybutyrate and poly-3-hydroxyhexanoate comprising at least 1 to at most 15 mole-percent poly-3-hydroxyhexanoate, preferably at least 3 to at most 11 mole-percent poly-3-hydroxyhexanoate, and most preferably at least 4 to at most 7 mole-percent poly-3-hydroxyhexanoate.

Poly(lactic acid) or polylactic acid or polylactide (PLA) is a biodegradable and bioactive thermoplastic aliphatic polyester typically derived from renewable resources, such as corn starch, tapioca roots, chips, starch, sugar beet, cellulose, or sugarcane.

There are several routes to usable (i.e. high molecular weight) PLA known in the art. Two main monomers are used: lactic acid, and the cyclic di-ester, lactide. The most common route to PLA is the ring-opening polymerization of lactide with various metal catalysts (typically tin octoate) in solution, in the melt, or as a suspension.

Another route to PLA is the direct condensation of lactic acid monomers. This process needs to be carried out at less than 200° C.; above that temperature, the entropically favoured lactide monomer is generated. This reaction generates one equivalent of water for every condensation (esterification) step, which may be undesirable because water causes chain-transfer leading to low molecular weight material. The direct condensation is thus preferably performed in a stepwise fashion, where lactic acid is first oligomerised to PLA oligomers. Thereafter, polycondensation is done in the melt or as a solution, where short oligomeric units are combined to give a high molecular weight polymer strand.

Polymerization of a racemic mixture of L- and D-lactides usually leads to the synthesis of poly-DL-lactide (PDLLA), which is amorphous. Use of stereospecific catalysts can lead to heterotactic PLA which has been found to show crystallinity. The degree of crystallinity, and hence many important properties, is largely controlled by the ratio of D to L enantiomers used, and to a lesser extent on the type of catalyst used. Apart from lactic acid and lactide, lactic acid O-carboxyanhydride (“lac-OCA”), a five-membered cyclic compound may be used academically as well. The direct biosynthesis of PLA similar to the poly(hydroxyalkanoate)s is possible as well.

In some embodiments, the PLA comprises PLLA (poly-L-lactide), PDLA (poly-D-lactide) or a mixture thereof, preferably PLLA.

In some preferred embodiments, the L-content in the PLLA is at least 90% by weight, preferably at least 95% by weight and more preferably at least 98% by weight, determined by NMR.

In some embodiments, the melt flow index (MFI) of the PLA is at least 0.5 g/10 min to at most 30 g/10 min, preferably at least 1 g/10 min to at most 20 g/10 min, more preferably at least 3 g/10 min to at most 10.0 g/10 min, and most preferably at least 4 g/10 min to at most 7 g/10 min measured according to D 1238, at 210° C. and under a load of 2.16 kg.

Polybutylene succinate (PBS) is a polymer that can be classified as a polyester, more preferably an aliphatic polyester, and most preferably a biodegradable aliphatic polyester. Polybutylene succinate comprises of repeating units of butylene succinate and can be represented by structure (II):

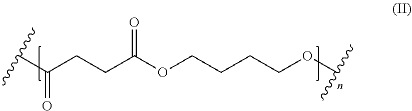

Many ways of producing polybutylene succinate are known in the art. One of them involves the esterification of succinic acid with 1,4-butanediol with the elimination of water, to form oligomers, which is followed by a trans-esterification under vacuum in the presence of a catalyst such as titanium, zirconium, tin or germanium derivatives, to provide high molecular mass polymer.

In some embodiments, the melting point of the polybutylene succinate ranges from 100 to 140° C., more preferably from 105 to 130° C., even more preferably from 110 to 125° C., and most preferably from 110 to 120° C., determined according to ISO 11357-1 (2016) using a heating rate of 10° C./min.

In some embodiments, the melt flow index (MFI) of the PBS is at least 0.1 g/10 min to at most 30.0 g/10 min, preferably at least 0.5 g/10 min to at most 20.0 g/10 min, more preferably at least 0.8 g/10 min to at most 10.0 g/10 min and most preferably at least 1.0 g/10 min to at most 5.0 g/10 min measured according to D 1238, at 190° C. and under a load of 2.16 kg.

Poly(butylene succinate-co-adipate) (PBSA) is a copolymer that can be classified as a polyester, more preferably an aliphatic polyester, and most preferably a biodegradable aliphatic polyester. Poly (butylene succinate-co-adipate) is a copolymer that comprises of repeating units of butylene succinate and butylene adipate and can be represented by structure (Ill):

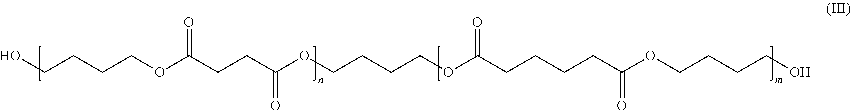

In some embodiments, the melt flow index (MFI) of the PBSA is at least 0.1 g/10 min to at most 30 g/10 min, preferably at least 0.5 g/10 min to at most 20.0 g/10 min, more preferably at least 0.8 g/10 min to at most 10.0 g/10 min and most preferably at least 1 g/10 min to at most 5 g/10 min measured according to D 1238, at 190° C. and under a load of 2.16 kg.

In some embodiments, the monomer units making up the PBSA comprise at least 1 to at most 15 mol % adipate, more preferably at least 3 to at most 10 mol % adipate, even more preferably at least 4 to at most 7 mol % adipate, and most preferably around 5 mol % adipate. It has been found that PBSA provides elasticity and softness to the filaments.

In some embodiments, the melting point of the PBSA ranges from 50 to 120° C., more preferably from 60 to 110° C., even more preferably from 70 to 100° C., and most preferably from 80 to 90° C., determined according to ISO 3146 (2000).

Polybutyrate adipate terephthalate (PBAT), also known as polybutyrate, is a biodegradable random copolymer, specifically a co-polyester of adipic acid, 1,4-butanediol and dimethyl terephthalate as represented in structure (IV).

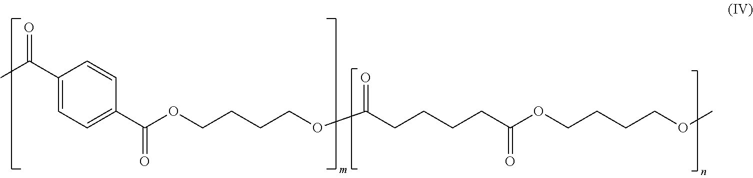

In some embodiments, the ratio between the amount moles of adipic acid over the amount of moles of dimethyl terephthalate in the PBAT is at least 0.1 at most 10.

In some embodiments, the melt flow index (MFI) of the PBAT is at least 0.1 g/10 min to at most 30.0 g/10 min, preferably at least 0.5 g/10 min to at most 20.0 g/10 min, more preferably at least 1.0 g/10 min to at most 10.0 g/10 min, even more preferably at least 2.0 g/10 min to at most 7.0 g/10 min and most preferably at least 2.5 g/10 min to at most 5.0 g/10 min measured according to ISO 1133:2005, at 190° C. and under a load of 2.16 kg.

In some preferred embodiments, the first layer comprises PBS and/or PBAT and the second layer comprises PCL, PBSA and/or PHA. In some more preferred embodiments, the first layer consists of PBS and/or PBAT and the second layer consists of PCL, PBSA and/or PHA.

In some alternative preferred embodiments, the first layer comprises PLA and the second layer comprises PBS and/or PBAT. In some more preferred embodiments, the first layer consists of PLA and the second layer consists of PBS and/or PBAT.

In some embodiments, the multilayered composite textile is a two-layered textile, preferably a first layer in the form of a coating layer applied on one side of a second layer, which comprises a fabric, made up from filaments.

In some alternative embodiments, the multilayered composite textile is a three-layered textile, preferably two first layers in the form of a coating layers applied on both sides of a second layer, which comprises a fabric, made up from filaments.

In some embodiments, the second layer is sandwiched between two first layers. In some embodiments, the second layer may be sandwiched between two first layers each of these first layers having a different composition.

The term “sandwiched” meaning that the second layer is directly positioned between two first layers. In some embodiments, the second layer may be sandwiched between two first layers each of these first layers having a different composition.

In some embodiments of the first, second and third aspect, the first biodegradable polymer is PHA and the second biodegradable polymer is PLA.

In some embodiments of the first, second and third aspect, a nucleating agent is added to the first layer and/or second layer. This reduces the stickiness of the filaments to rolls in the handling equipment.

In some embodiments, the first layer and/or the second layer comprise a filler, preferably at least 0.1 to at most 10.0 percent by weight, more preferably at least 0.5 to at most 7.0 percent by weight, even more preferably at least 1.0 to at most 5.0 percent by weight, and most preferably at least 2.0 to at most 3.0 percent by weight of the filler; wherein the percentage by weight is expressed compared to the total weight of the relevant layer.

In some embodiments, the first layer and/or the second layer comprise a filler, preferably wherein the filler is selected from the group comprising: chalk; silica, such as precipitated silicas; clay; mica; dolomite; talc; zinc borate; magnesium carbonate; calcium oxide; calcium carbonate; calcium silicate; sodium aluminium silicate; calcium metasilicate; titanium dioxide; diatomaceous earth, barium sulphate, cork, wood-dust, wood-fibre, bamboo, lignin, desiccators, and/or algae and derivatives thereof more preferably the filler is chalk and/or talc, most preferably chalk.

In some embodiments, the second layer comprises degradation accelerators, such as attractants, proteins, sugars, salts, algae, enzymes, spores, microbial fungi, absorbent polymers and the like.

The quality of pigments and their dispersion in the melt, can be gauged by filter pressure value test (FPV), according to EN 13900-5:2005 using filter screen-pack 3.

In some embodiments, the FPV is at most 30 bar/g, preferably at most 20 bar/g, more preferably at most 15 bar/g, even more preferably at most 10 bar/g, and most preferably at most 5 bar/g. Especially when the filament is a yarn, the FPV value of the filler may be at most 10 bar/g, more preferably at most 1 bar/g. When the filament is a slit film tape, the average particle size of the filler may be at most 30 bar/g, preferably at most 20 bar/g, more preferably at most 15 bar/g, even more preferably at most 10 bar/g, and most preferably at most 5 bar/g.

In some embodiments, the first layer and/or the second layer comprise chalk, preferably wherein the first layer and/or the second layer comprise at least 1.0 to at most 5.0 percent by weight, more preferably from 1.5 to 3.0 percent by weight of chalk; wherein the percentage by weight is expressed compared to the total weight of the relevant layer. Especially the use of chalk as a filler helps to prevent splitting of filaments during handling, e.g. weaving.

In some embodiments, the first layer and/or the second layer comprise an additive, for example selected from the group comprising: pigments and pigment pastes, dyes, stabilizers, anti-oxidants, bactericides, fungicides, algaecides, insecticides, rheological modifiers, UV-absorbers, waxes, mineral oils, flame retardants, diluents, elastomers, plasticizers, absorbents, reinforcing agents, plasticizers, odorants, corrosion inhibitors, and combinations thereof.

In some embodiments, the first layer and/or the second layer comprise degradation accelerators, such as attractants, proteins, sugars, salts, algae, absorbent polymers and the like.

In some embodiments, the first layer has a thickness of at least 0.1 μm to at most 50 μm, preferably at least 0.5 μm to at most 40 μm, more preferably at least 0.7 μm to at most 30 μm, still more preferably at least 1 μm to at most 20 μm, even more preferably at least 2 μm to at most 15 μm and most preferably at least 3 μm to at most 10 μm, such as at least 4 μm to at most 5 μm.

In some embodiments, the second layer has a thickness of at least 3 μm to at most 100 μm, preferably at least 5 μm to at most 90 μm, more preferably at least 7 μm to at most 80 μm, still more preferably at least 10 μm to at most 70 μm, even more preferably at least 15 μm to at most 60 μm and most preferably at least 18 μm to at most 55 μm, such as at least 20 μm to at most 50 μm.

In some embodiments, the multilayered composite textile has a thickness of at least 30 μm to at most 1500 μm, preferably at least 50 μm to at most 1200 μm, more preferably at least 100 μm to at most 1000 μm, still more preferably at least 200 μm to at most 800 μm, even more preferably at least 300 μm to at most 600 μm. In some embodiments, the multilayered composite textile is a geotextile or an agrotextile, preferably a groundcover. Preferably, said multilayered composite textile has a weight of at least 30 g/m² to at most 1000 g/m², preferably at least 50 g/m² to at most 800 g/m², more preferably at least 60 g/m² to at most 500 g/m², even more preferably at least 70 g/m² to at most 300 g/m² and most preferably at least 80 g/m² to at most 200 g/m².

In some embodiments, the multilayered composite textile is suitable to be used for temporary weed control, preferably said multilayered composite textile has a weight of at least 30 g/m² to at most 500 g/m², preferably at least 50 g/m² to at most 300 g/m², more preferably at least 70 g/m² to at most 200 g/m², even more preferably at least 90 g/m² to at most 150 g/m² and most preferably around 110 g/m².

In some embodiments, the multilayered composite textile is suitable to be used for temporary erosion control, wherein said multilayered composite textile has a weight of at least 50 g/m² to at most 1000 g/m², preferably at least 100 g/m² to at most 800 g/m², more preferably at least 150 g/m² to at most 600 g/m², even more preferably at least 200 g/m² to at most 400 g/m² and most preferably around 300 g/m².

In some embodiments, the multilayered composite textile is suitable to be used as temporary packaging material.

In a second aspect, the invention provides in a method for manufacturing a multilayered composite textile, preferably according to the first aspect or an embodiment thereof, comprising the steps of:
providing second layer filaments, comprising a second biodegradable polymer;
forming, preferably weaving, said second layer filaments into a second layer fabric;
covering said second layer fabric with at least one first layer, wherein the first layer comprises a first biodegradable polymer, to obtain a multilayered composite textile, preferably wherein the visual degradation speed of the first biodegradable polymer is slower than the visual degradation speed of the second biodegradable polymer.

Additionally, the second aspect provides in a method for manufacturing a multilayered composite textile, preferably according to the first aspect or an embodiment thereof, comprising the steps of:
providing second layer filaments, comprising a second biodegradable polymer;
forming, preferably weaving, said second layer filaments into a second layer fabric;
covering said second layer fabric with at least one first layer, wherein the first layer comprises a first biodegradable polymer, to obtain a multilayered composite textile, wherein the first biodegradable polymer comprises polybutylene succinate (PBS), polylactic acid (PLA) and/or polybutyrate (PBAT); and wherein the second biodegradable polymer comprises polycaprolactone (PCL), polybutylene succinate-co-adipate (PBSA), and/or polyhydroxyalkanoate (PHA).

Additionally, the second aspect provides in a method for manufacturing a multilayered composite textile, preferably according to the first aspect or an embodiment thereof, comprising the steps of:
providing second layer filaments, comprising a second biodegradable polymer;
forming, preferably weaving, said second layer filaments into a second layer fabric;
covering said second layer fabric with at least one first layer, wherein the first biodegradable polymer comprises polylactic acid (PLA); and wherein the second biodegradable polymer comprises polybutylene succinate (PBS) and/or polybutyrate (PBAT).

In some embodiments, the covering step is performed by dip coating one layer with the other layer, hot melt coating one layer with the other layer, powder coating one layer with the other layer, spray coating one layer with the other layer, applicator coating one layer with the other layer, co-extrusion, bi-component extrusion, extrusion coating, lamination or via plasma treatment of at least one layer, preferably dip coating, hot-melt coating or co-extrusion. The polymer during coating can be used as a solid, as a powder, as a solution, as a dispersion, as an emulsion or as a melt.

In some preferred embodiments, the covering step is performed by dip coating one layer with the other layer, hot melt coating one layer with the other layer, co-extrusion, bi-component extrusion, laminating or via plasma treatment of at least one layer.

In some more preferred embodiments, the second layer fabric is dip-coated with the first biodegradable polymer.

In some embodiments, the second biodegradable polymer and optionally the first biodegradable polymer is extruded as a film. The film can be either a blown film or a cast film. Film production is easier with processed material having high melt flow index; preferably the melt flow index of the biodegradable polymers is at least 1 g/10 min, preferably at least 2 g/10 min, more preferably at least 4 g/10 min, as measured according to ISO 1133:2005 at 190° C. under a weight of 2.16 kg. Conventional blown film extrusion techniques and equipment therefor is known in the art and is commercially available. Also, conventional cast film extrusion techniques and equipment therefor is known in the art and is commercially available.

In some embodiments, during extrusion of PCL, PLA, PBS, PBAT and PHA, the temperature of the extrusion head or die channel is from 150 to 220° C., preferably from 160 to 210° C., more preferably from 165 to 200° C. Most preferably the temperature of the extrusion head or die channel is about 200 to 220° C. for extruding PLA, about 200° C. for extruding PCL, maximum 180° C. for extruding PHA and about 190° C. for PBS, PBSA and/or PBAT. In some embodiments, orientation of the filaments, the film or of the cut slit film tapes is carried out by stretching while passing through an air oven, infra-red (IR) oven or over a hot plate, maintained at a certain temperature. Preferably the temperature is from 40 to 80° C., more preferably from 45 to 75° C., even more preferably from 50 to 70° C., and most preferably from 55 to 65° C., when the filament comprises more than 50% by weight PCL. Preferably the temperature is from 80 to 140° C., more preferably from 90 to 130° C., even more preferably from 100 to 120° C., and most preferably from 105 to 115° C., for example 110° C. when the filament comprises more than 50% PHA, PBAT, PBS or PLA.

Preferably, the oven temperature is from 5 to 70° C., preferably from 10 to 50° C., more preferably from 15 to 30° C. lower than the melting temperature of the average from the meting temperature of the first biodegradable polymer and the second biodegradable polymer.

Preferably, the stretched filaments, film or slit film tapes are annealed immediately after the stretching operation in order to minimize shrinkage that could occur as a result of residual stresses in the stretched filaments, film or tapes.

Preferably, a spin finish may be applied to the filaments, more preferably the spin finish is biodegradable and/or non-toxic. An example of a suitable spin finish is DURON OF 2173 sold by CHT group.

Preferably, the filaments are wound on bobbins.

Preferably, the filaments, preferably the slit film tapes are woven into a tissue or a fabric, preferably the second layer fabric.

In a third aspect, the invention provides in the use of a multilayered composite textile according to the first aspect or an embodiment thereof, or a multilayered composite textile manufactured by a method according to the second aspect or an embodiment thereof, as temporary weed control, as temporary erosion control, as a hygienic article, or as temporary packaging material.

As used herein, the term “temporary packaging material” includes amongst others, degradable bags, protective bags or covers (eg for hydrocultivation, protection of grape bunches or other fruit/vegetables), body bags, teabags or coffee pads.

In some embodiments, the multilayered composite textile is used as temporary weed control.

In some embodiments, the multilayered composite textile is used as temporary weed control. Preferably, the first layer comprises PLA. Preferably, the second layer comprises PBS and/or PBAT. In a preferred embodiment, the multilayered composite textile comprises one first layer and one second layer. In a more preferred embodiment, the multilayered composite textile comprises two first layers and one second layer, preferably wherein the second layer is sandwiched between the two first layers.

In some embodiments, the multilayered composite textile is used as temporary erosion control. Preferably, the first layer comprises PBS and/or PBAT Preferably, the second layer comprises PCL and/or PHA. In a preferred embodiment, the multilayered composite textile comprises one first layer and one second layer. In a more preferred embodiment, the multilayered composite textile comprises two first layers and one second layer, preferably wherein the second layer is sandwiched between the two first layers.

In some embodiments, the multilayered composite textile is used as temporary erosion control. Preferably, the first layer comprises PLA. Preferably, the second layer comprises PBS and/or PBAT. In a preferred embodiment, the multilayered composite textile comprises one first layer and one second layer. In a more preferred embodiment, the multilayered composite textile comprises two first layers and one second layer, preferably wherein the second layer is sandwiched between the two first layers.

In some embodiments, the multilayered composite textile is used as temporary packaging material. Preferably, the first layer comprises PBS and/or PBAT, the second layer comprises PCL and/or PHA. In a preferred embodiment, the multilayered composite textile comprises one first layer and one second layer. In a more preferred embodiment, the multilayered composite textile comprises two first layers and one second layer, preferably wherein the second layer is sandwiched between the two first layers.

In some embodiments, the multilayered composite textile is used as temporary packaging material. Preferably, the first layer comprises PLA. Preferably, the second layer comprises PBS and/or PBAT. In a preferred embodiment, the multilayered composite textile comprises one first layer and one second layer. In a more preferred embodiment, the multilayered composite textile comprises two first layers and one second layer, preferably wherein the second layer is sandwiched between the two first layers.

In some embodiments, the multilayered composite textile is used as or in a hygienic article. Preferably, the first layer comprises PBS and/or PBAT. Preferably, the second layer comprises PCL and/or PHA. In a preferred embodiment, the multilayered composite textile comprises one first layer and one second layer. In a more preferred embodiment, the multilayered composite textile comprises two first layers and one second layer, preferably wherein the second layer is sandwiched between the two first layers.

In some embodiments, the multilayered composite textile is used as or in a hygienic article. Preferably, the first layer comprises PLA. Preferably, the second layer comprises PBS and/or PBAT. In a preferred embodiment, the multilayered composite textile comprises one first layer and one second layer. In a more preferred embodiment, the multilayered composite textile comprises two first layers and one second layer, preferably wherein the second layer is sandwiched between the two first layers.

As used herein, the term “hygienic article” includes amongst others, diapers, fem care articles and wipes.

The invention will be more readily understood by reference to the following examples, which are included merely for purpose of illustration of certain aspects and embodiments of the present invention and are not intended to limit the invention.

### Examples

Unless otherwise indicated, all parts and all percentages in the following examples, as well as throughout the specification, are parts by weight or percentages by weight respectively.

### Accelerated Visual Disintegration Test

A test that can be used to compare the visual disintegration of textiles, filaments layers or groundcovers is the ISO 20200:2015 International Standard. However, the test used in the examples differs from ISO 20200:2015 in that the test itself is carried out at 28° C., and the filaments are completely covered on both sides with compost. Herein, this test is referred to as modified ISO 20200:2015.

The compost is made from fresh vegetables, fruit and garden waste. The composting lasted for 12 weeks at a temperature 58±2° C. (industrial composting conditions). After 12 weeks, the compost is sieved and the fraction<10 mm is used. At the beginning of the test, a mixture of 80% by weight of said compost and 20% fresh vegetable and fruit waste from a restaurant is prepared, which is used in the two testing boxes, to duplicate the results. Samples are suspended in slide mount frames and placed in the box completely covered with the mixture. The samples/slide frames are not being dried or moistened before they enter the boxes. The slide frames are dug out and reburied in the same compost every 2 weeks. During the test, the temperature is maintained at 28±2° C. Moisture content of the mixture is maintained between 40 and 60% by weight. Humidity of compost material can be assessed by the “fist-test” (Bundersgutegemeischaft Kompost e.V. (FCQAO), Methods Book 2002).

Using these test conditions, the acceleration factor is estimated at approximately 6, meaning that the when the filaments of the invention are used on the surface of soil exposed to the elements in a Cfb-climate, such as Belgium, the visual disintegration will be approximately 6 times slower. Hence, 26 weeks in the accelerated visual disintegration test corresponds to approximately 3 years under Cfb-climate conditions, wherein the filaments are in touch with soil at only one side.

It is to be understood that although preferred embodiments and/or materials have been discussed for providing embodiments according to the present invention, various modifications or changes may be made without departing from the scope and spirit of this invention.

1. A multilayered composite textile, comprising:
at least one first layer, comprising a first biodegradable polymer; and, at least one second layer, comprising a second layer fabric wherein the second layer fabric comprises second layer filaments;
wherein said second layer fabric comprises a second biodegradable polymer, wherein the visual degradation speed of the first layer is slower than the visual degradation speed of the second layer.

2. The multilayered composite textile according to claim 1, wherein the first layer comprises a coating comprising the first biodegradable polymer.

3. The multilayered composite textile according to claim 1, wherein the second layer fabric is a woven fabric or non-woven fabric; and/or wherein the second layer filaments are slit film tapes, fibres, or yarns.

4. The multilayered composite textile according to claim 1, wherein the visual degradation speed of the first layer is at least 50% slower than the visual degradation speed of the second layer, under conditions according to modified ISO 20200:2015.

5. The multilayered composite textile according to claim 1, wherein the first layer comprises polybutylene succinate (PBS) and/or polybutyrate (PBAT) as first biodegradable polymer, wherein the first layer comprises at least 50 to at most 100 percent by weight PBS and/or PBAT, the percentage by weight expressed compared to the total weight of the first layer.

6. The multilayered composite textile according to claim 1, wherein the first layer comprises polylactic acid (PLA) as first biodegradable polymer, wherein the first layer comprises at least 50 to at most 100 percent by weight PLA, the percentage by weight expressed compared to the total weight of the first layer.

7. The multilayered composite textile according to claim 1, wherein the second layer comprises polycaprolactone (PCL), polybutylene succinate-co-adipate (PBSA), polyhydroxyalkanoate (PHA), or a mixture thereof, wherein the second layer comprises at least 50 to at most 100 percent by weight PCL, PBSA and/or PHA, the percentage by weight expressed compared to the total weight of the second layer.

8. The multilayered composite textile according to claim 1, wherein the second layer comprises polybutylene succinate (PBS) and/or polybutyrate (PBAT) as second biodegradable polymer, wherein the second layer comprises at least 50 to at most 100 percent by weight PBS and/or PBAT the percentage by weight expressed compared to the total weight of the second layer.

9. The multilayered composite textile according to claim 1, wherein the second layer is sandwiched between two first layers.

10. The multilayered composite textile according to claim 1, wherein the first layer has a thickness of at least 0.1 pm to at most 50 pm and/or wherein the second layer has a thickness of at least 3 pm to at most 100 pm.

11. The multilayered composite textile according to claim 1, wherein the multilayered composite textile is a geotextile or an agrotextile.

12. Method for manufacturing a multilayered composite textile, comprising the steps of:
providing second layer filaments, comprising a second biodegradable polymer;
forming said second layer filaments into a second layer fabric;
covering said second layer fabric with at least one first layer, wherein the first layer comprises a first biodegradable polymer, to obtain a multilayered composite textile,
wherein the visual degradation speed of the first biodegradable polymer is slower than the visual degradation speed of the second biodegradable polymer.

13. Method according to claim 12, wherein the covering step is performed by dip coating one layer with the other layer, hot melt coating one layer with the other layer, co-extrusion, bi-component extrusion, laminating, or via plasma treatment of at least one layer.

14. Method according to claim 12, wherein the second layer fabric is dip-coated with the first biodegradable polymer.

15. A method comprising using the multilayered composite textile according to claim 1 for temporary weed control, as temporary erosion control, as a hygienic article, or as temporary packaging material.

16. A method comprising using the multilayered composite textile manufactured by a method according claim 12 for temporary weed control, as temporary erosion control, as a hygienic article, or as temporary packaging material.
